(19) United States
(12) Patent Application Publication
(10) Pub. No.: US 2026/0189449 A1
(43) Pub. Date: Jul. 2, 2026

(54) COMMUNICATION DEVICE AND NETWORK CONTROL METHOD THAT HAVE DEVICE GROUPING MECHANISM

(71) Applicant: REALTEK SEMICONDUCTOR CORPORATION, HSINCHU (TW)

(72) Inventors: CHO-HAN YU, Hsinchu (TW); SHAU-YU CHENG, Hsinchu (TW); CHUN-KAI TSENG, Hsinchu (TW)

(21) Appl. No.: 19/412,963

(22) Filed: Dec. 9, 2025

(30) Foreign Application Priority Data
Dec. 31, 2024 (TW) 113151821

(51) Int. Cl. H04L 27/26; H04L 5/00

(52) U.S. Cl. CPC H04L 27/2646; H04L 5/0037; H04L 5/006

(57) ABSTRACT

A communication device includes a transceiver circuit and a controller circuit. The transceiver circuit is configured to receive packets from electronic devices. The controller circuit is configured to: parse the packets to obtain power delay profile of each of the electronic devices; set a guard interval of each of the electronic devices according to the power delay profile; divide the electronic devices into a first group of devices and a second group of devices; and sending, through the transceiver circuit, a trigger frame to at least one group of devices in the first or the second group of devices, such that the at least one group of devices upload data to the transceiver circuit.

### BACKGROUND OF THE INVENTION

### 1. Field of the Invention

The present disclosure relates to a communication device, and particularly to a communication device and a network control method thereof that are capable of grouping devices based on power delay profile.

### 2. Description of Related Art

In multi-user input-output communication applications, data transmissions between devices may cause inter-symbol interference (ISI), which distorts received data. Additionally, data transmission of a single device may be distorted by multipath effects. To address these problems, existing communication standards propose using a guard interval to mitigate ISI. However, in the existing approaches, when devices need to transmit data simultaneously, the guard interval of the devices may be fixed to the maximum predetermined time, such that the lengths of other fields (such as but not limited to a long training field) of the packet also need to be increased, resulting in a reduction in the proportion of payload data and a decrease in channel utilization.

### SUMMARY OF THE INVENTION

In some aspects, an object of the present disclosure is, but not limited to, providing a communication device and a network control method thereof that are capable of grouping devices based on power delay profile, so as to make an improvement to the prior art.

In some aspects, a communication device includes a transceiver circuit and a controller circuit. The transceiver circuit is configured to receive a plurality of packets from a plurality of electronic devices. The controller circuit is configured to: parse the plurality of packets to obtain a power delay profile of each of the plurality of electronic devices; set a guard interval of each of the plurality of electronic devices according to the power delay profile; divide the plurality of electronic devices into a first group of devices and a second group of devices according to the guard interval; and send, through the transceiver circuit, a trigger frame to at least one group of devices in the first group of devices or the second group of devices, so that the at least one group of devices uploads data to the transceiver circuit.

In some aspects, a network control method, performed by a communication device, includes the following operations: receiving a plurality of packets from a plurality of electronic devices; parsing the plurality of packets to obtain a power delay profile of each of the plurality of electronic devices; setting a guard interval of each of the plurality of electronic devices according to the power delay profile; dividing the plurality of electronic devices into a first group of devices and a second group of devices according to the guard interval; and sending a trigger frame to at least one group of devices in the first group of devices or the second group of devices, so that the at least one group of devices uploads data to the communication device.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a communication device according to some embodiments of the present disclosure.

FIG. 2 illustrates a flowchart of a network control method according to some embodiments of the present disclosure.

FIG. 3A illustrates a schematic diagram of a trigger frame sent by the communication device of FIG. 1 and its received packet according to some embodiments of the present disclosure.

FIG. 3B illustrates a schematic diagram of power delay profile obtained based on the packet of FIG. 3A according to some embodiments of the present disclosure.

FIG. 3C illustrates a schematic diagram of a trigger frame sent by the communication device of FIG. 1 and its received packet according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

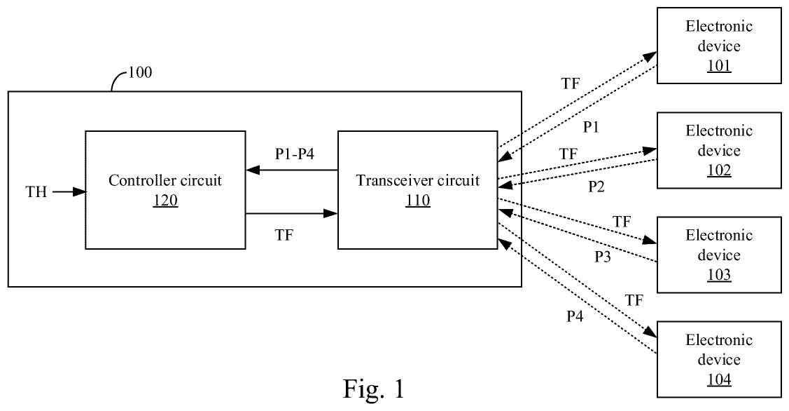

FIG. 1 illustrates a schematic diagram of the communication device 100 according to some embodiments of the present disclosure. In some embodiments, the communication device 100 may be applied in an orthogonal frequency division multiplexing (OFDM) system. The communication device 100 includes a transceiver circuit 110 and a controller circuit 120. The transceiver circuit 110 may receive packets P1-P4 from electronic devices 101-104 and, based on the control of the controller circuit 120, may send a trigger frame TF to the electronic devices 101-104. In some embodiments, the communication device 100 may operate as an access point, and the electronic devices 101-104 may operate as stations, but the present disclosure is not limited thereto. In some embodiments, in the IEEE 802.11ax and its successor wireless network standards, the trigger frame TF may be employed to indicate settings related to data transmission of the electronic devices 101-104. For example, the trigger frame TF may indicate information such as a modulation and coding scheme (MCS), resource unit allocation, and guard interval corresponding to each of the electronic devices. After receiving the trigger frame TF, the electronic devices 101-104 may perform corresponding configurations according to the information contained in the trigger frame TF to start uploading data (for example, the packets P1-P4) to the transceiver circuit 110.

The controller circuit 120 may parse the packets P1-P4 to obtain a power delay profile of each of the electronic devices 101-104. For example, the controller circuit 120 may parse the packet P1 according to the above wireless network standard to obtain channel state information from a long training field in the packet P1 and obtain the power delay profile based on the channel state information. In some embodiments, the aforementioned long training field may be, but is not limited to, a high efficiency (HE) long training field for channel estimation and supporting multi-user multiple-input multiple-output (MIMO). In some embodiments, the power delay profile is configured to indicate a relationship between multiple signal strength (for example, a signal strength of the packet P1) of a corresponding one of the electronic devices 101-104 (for example, the electronic device 101) received by the transceiver circuit 110 through multiple paths and multiple delay times. In some embodiments, the aforementioned multiple paths may include a light-of-sight (LOS) path and a non-LOS path between the communication device 100 and each of the electronic devices 101-104. The above-mentioned related information or packet formats may be understood with reference to the specification of the above wireless network standard and thus are not described further herein.

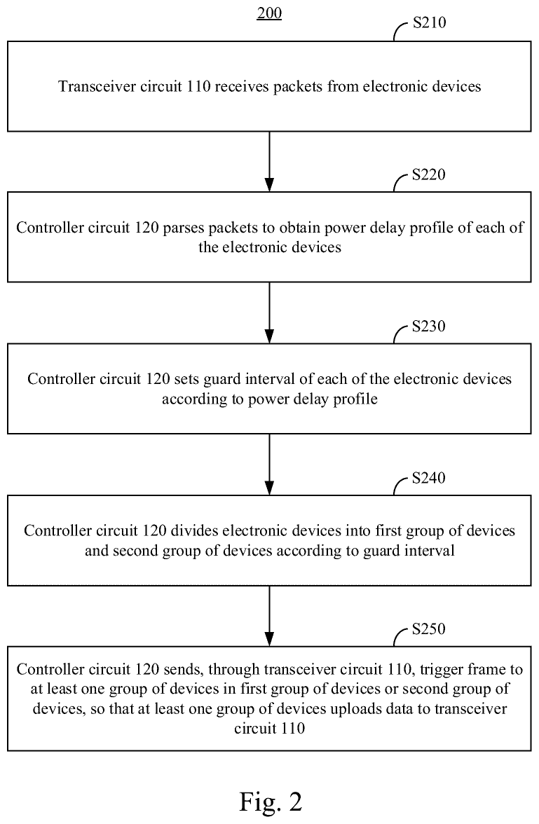

In some embodiments, the transceiver circuit 110 includes a transmitter circuit and a receiver circuit that may transmit and receive radio frequency signals (or higher-frequency signals). In some embodiments, the controller circuit 120 may be implemented by software (or firmware), hardware, or a combination thereof. For example, in some embodiments, the controller circuit 120 is implemented by a processor circuit or a microcontroller circuit that may perform the related operations of FIG. 2, in which the related operations of FIG. 2 may be implemented with software (or firmware), and the processor circuit (or the microcontroller circuit) may perform the related operations of FIG. 2 by executing the software (or firmware). The above arrangements regarding the transceiver circuit 110 and/or the controller circuit 120 are given for illustrative purposes, and the present disclosure is not limited thereto.

It is understood that, according to practical application requirements, the communication device 100 may be coupled to one or more electronic devices to exchange data through the above wireless network standard. Therefore, the number of electronic devices shown in FIG. 1 is given for illustrative purposes, and the present disclosure is not limited thereto.

FIG. 2 illustrates a flowchart of a network control method 200 according to some embodiments of the present disclosure. In some embodiments, the network control method 200 may be performed by the communication device 100 of FIG. 1, but the present disclosure is not limited thereto.

In operation S210, the transceiver circuit 110 receives packets from the electronic devices. In some embodiments, based on the above wireless network standard, the communication device 100 may periodically send a single-user trigger frame (not shown) to a corresponding one of the electronic devices 101-104, so that the corresponding one of the electronic devices 101-104 may send a corresponding packet in the packets P1-P4 to the communication device 100 in response to the single-user trigger frame. In some embodiments, a single-user trigger frame is configured to trigger a single device to transmit data to the communication device 100 within the same period. In some embodiments, based on the above wireless network standard, the communication device 100 may send a single-user packet (not shown) to the electronic devices 101-104, and the electronic devices 101-104 may perform channel contention in response to the single-user packet, so as to send the packets P1-P4 to the communication device 100. With the above arrangements, the communication device 100 may obtain the packets P1-P4 from the electronic devices 101-104.

In operation S220, the controller circuit 120 parses the packets to obtain a power delay profile of each of the electronic devices. In operation S230, the controller circuit 120 sets a guard interval of each of the electronic devices according to the power delay profile. In operation S240, the controller circuit 120 divides the electronic devices into a first group of devices and a second group of devices according to the guard interval. In operation S250, the controller circuit 120 sends, through the transceiver circuit 110, a trigger frame to at least one group of devices in the first group of devices or the second group of devices, so that the at least one group of devices uploads data to the transceiver circuit 110.

Operations in the network control method 200 may include exemplary operations, but the operations in the network control method 200 are not necessarily performed in the order described above. The operations in the network control method 200 may be added, replaced, changed order, and/or eliminated, or one or more operations in the network control method 200 may be executed simultaneously or partially simultaneously as appropriate, in accordance with the spirit and scope of various embodiments of the present disclosure.

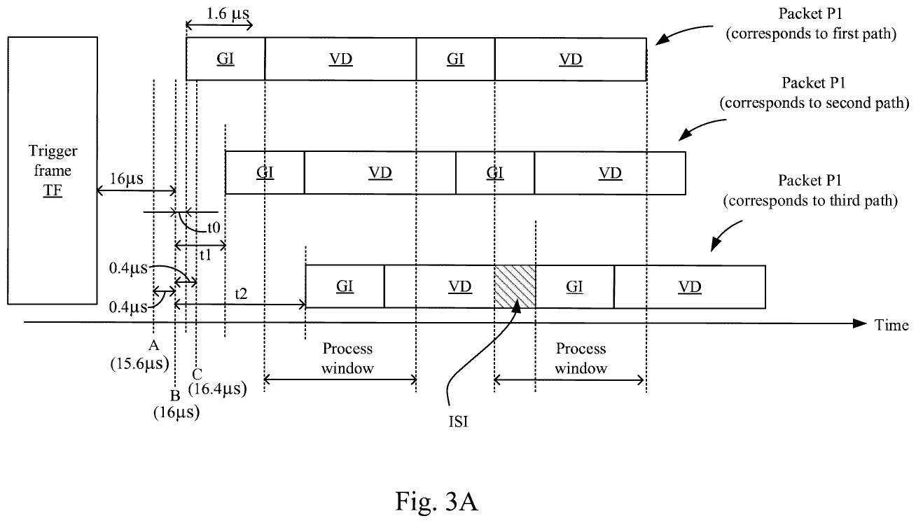

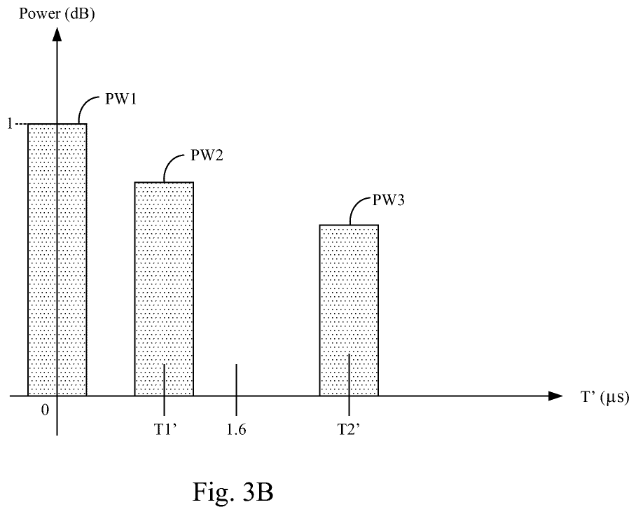

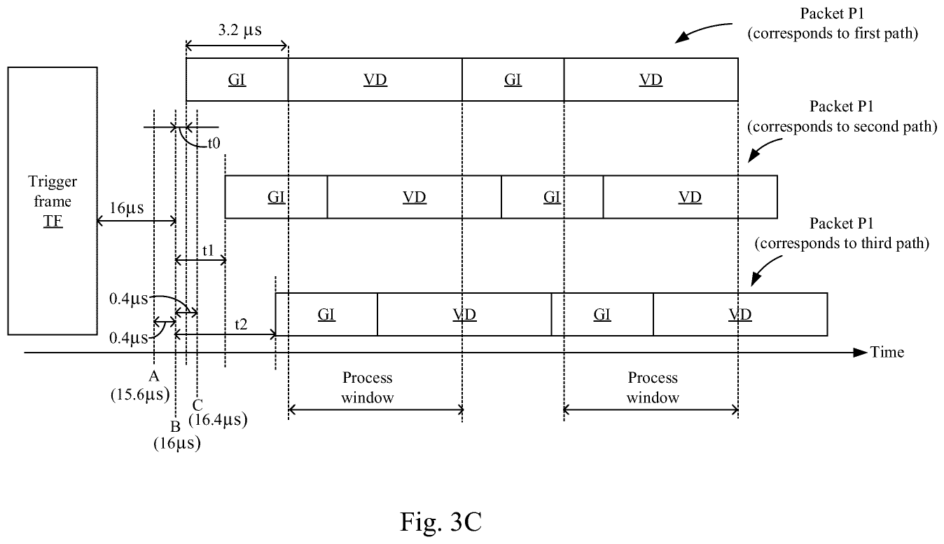

The following paragraphs further illustrate the related operations of FIG. 2 with reference to FIGS. 3A-3C. FIG. 3A illustrates a schematic diagram of a trigger frame TF sent by the communication device 100 of FIG. 1 and its received packet P1 according to some embodiments of the present disclosure.

According to timing offset requirements in the above wireless network standard, each of the electronic devices 101-104 may be required to send a corresponding one of the packets P1-P4 within 15.6 microseconds (μs) to 16.4 μs (i.e., a nominal value of 16 μs±0.4 μs) after the communication device 100 sends the trigger frame TF. In FIG. 3A, time A is 15.6 μs, time B is 16 μs, and time C is 16.4 μs. In practical application environments, a signal transmitted by a single electronic device may arrive at the communication device 100 through different paths due to multipath effects (for example, the above-mentioned LOS path and non-LOS path). Taking the electronic device 101 as an example, as shown in FIG. 3A, the signal corresponding to the packet P1 arrives at the communication device 100 through three paths.

The data format of the packet P1 includes a guard interval GI and payload data VD, in which the guard interval GI is a cyclic prefix that is set to be the same as tail data of the payload data VD (for example, the last few bits) to reduce the influence of intersymbol interference (ISI). In this example, according to the above wireless network standard, a time length of the guard interval GI is set to 1.6 μs. A difference between a sending time of the packet P1 on the first path and the time B is a delay time to. A difference between a sending time of the packet P1 on the second path and the time B is a delay time t1. A difference between a sending time of the packet P1 on the third path and the time B is a delay time t2. As the delay time t2 is too long, the communication device 100 still suffers from ISI when decoding the packet P1 in a process window according to the above wireless network standard. For example, in a second process window, the payload data VD on the third path is still affected by previous payload data VD, resulting in the communication device 100 obtaining a distorted packet P1 in that process window. In other words, even if a single data transmission of the electronic device 101 meets the requirements of the above wireless network standard, the packet P1 may still be distorted due to ISI caused by multiple paths.

FIG. 3B illustrates a schematic diagram of a power delay profile obtained from the packet P1 of FIG. 3A according to some embodiments of the present disclosure. As described above, the controller circuit 120 may parse the packet P1 according to the above wireless network standard to obtain the power delay profile from the packet P1 (i.e., operation S220). The power delay profile may be represented as FIG. 3B, in which the horizontal axis indicates a delay time T′ (which is a delay time between a signal arrival time in a corresponding path and a signal arrival time of a first path of multiple signal paths, which is the earliest signal arrival time; the unit is μs), and the vertical axis is power (the unit may be decibels (dB)). In some embodiments, the signal power of FIG. 3B indicates a ratio between signal strength of a corresponding path and signal strength of a first path, that is, the signal strength of the corresponding path is normalized based on the signal strength of the first path. For example, signal strength of the packet P1 transmitted through the first path of FIG. 3A corresponds to a power PW1 in FIG. 3B (its delay time is 0, that is, t0−t0). Signal strength of the packet P1 transmitted through the second path of FIG. 3A corresponds to a power PW2 in FIG. 3B (its delay time T1′ may be expressed as t1−t0). Similarly, signal strength of the packet P1 transmitted through the third path of FIG. 3A corresponds to a power PW3 in FIG. 3B (its delay time T2′ may be expressed as t2−t0).

In some embodiments, the controller circuit 120 may calculate a sum of multiple signal strength of the packet P1 in a first predetermined period, and compare the sum with a threshold value TH to selectively set a guard interval of the electronic device 101 to a first predetermined time or a second predetermined time. In some embodiments, according to the above wireless network standard, the guard interval may be set to the first predetermined time or a longer second predetermined time, for example, the first predetermined time may be 1.6 μs, and the second predetermined time may be 3.2 μs. In some embodiments, the controller circuit 120 may set the threshold value TH according to a sum of all signal strength in the power delay profile. For example, the threshold value TH may be set at about 60% of the sum of signal strength of the power PW1, the power PW2 and the power PW3, but the present disclosure is not limited thereto. If the sum of signal strength of the power PW1, the power PW2, and the power PW3 in the first predetermined time (for example, 1.6 μs) (in the example of FIG. 3B, it is the sum of signal strength of the power PW1 and the power PW2) exceeds the threshold value TH, it indicates that a distribution of delay time of multiple paths is relatively concentrated. Under this condition, the controller circuit 120 may set the guard interval of the electronic device 101 to the shorter first predetermined time. Alternatively, if the sum of signal strength of the power PW1, the power PW2, and the power PW3 in the first predetermined time does not exceed the threshold value TH, it indicates that the distribution of delay time of multiple paths is relatively dispersed. Under this condition, the controller circuit 120 may set the guard interval of the electronic device 101 to the longer second predetermined time to avoid (or mitigate) ISI caused by multiple paths, thereby improving receiving performance of the communication device 100.

FIG. 3C illustrates a schematic diagram of a trigger frame TF sent by the communication device 100 of FIG. 1 and its received packet P1 according to some embodiments of the present disclosure. Different from FIG. 3A, in response to the trigger frame TF sent by the communication device 100, the electronic device 101 may increase a data length of a cyclic prefix of the packet P1 according to guard interval information indicated by the trigger frame TF to switch the guard interval GI to the longer second predetermined time. As shown in FIG. 3C, as the guard interval GI is adjusted to the longer second predetermined time (for example, 3.2 μs), the communication device 100 does not suffer from ISI caused by multiple paths (or suffers less) when decoding the packet P1 in each process window according to the above wireless network standard.

With the above operations, the controller circuit 120 may obtain corresponding power delay profile by parsing the packets P1-P4 and set guard intervals of the electronic devices 101-104 accordingly. For example, according to multiple power delay profile, the controller circuit 120 may record a correspondence between guard intervals of the electronic devices 101-104 as the following table:

| Electronic device | Guard interval (μs) |
|---|---|
| 101 | 1.6 |
| 102 | 3.2 |
| 103 | 3.2 |
| 104 | 1.6 |

The controller circuit 120 may divide the electronic devices 101-104 into the first group of devices and the second group of devices according to the table. For example, the electronic device 101 and the electronic device 104, which have a guard interval of 1.6 μs (that is, the above first predetermined time), may be divided into the first group of devices, and the electronic device 102 and the electronic device 103, which have a guard interval of 3.2 μs (that is, the above second predetermined time), may be divided into the second group of devices (i.e., operation S240). In some embodiments, the controller circuit 120 may include a memory circuit (not shown) that may store the aforementioned power delay profile and the above grouping information.

In some embodiments, the controller circuit 120 may send the trigger frame TF to set guard intervals of the electronic devices 101-104 and the above grouping information. Thus, the first group of devices (for example, the electronic device 101 and the electronic device 104) having the same guard interval may perform transmission simultaneously, and the second group of devices (for example, the electronic device 102 and the electronic device 103) having the same guard interval may perform transmission simultaneously, to reduce ISI between the electronic devices 101-104 and ISI caused by multiple paths of a single electronic device and to improve channel usage efficiency. For example, in response to the trigger frame TF, the electronic device 101 and the electronic device 104 in the first group of devices may set a data length of the cyclic prefix in the packet P1 and the packet P4 to set the guard interval to 1.6 μs and start uploading data to the communication device. Alternatively, in response to the trigger frame TF, the electronic device 102 and the electronic device 103 in the second group of devices may set a data length of the cyclic prefix in the packet P2 and the packet P3 to set the guard interval to 3.2 μs and start uploading data to the communication device. In some embodiments, if all the electronic devices 101-104 need to upload data simultaneously (that is, both the first group of devices and the second group of devices need to upload data simultaneously), the controller circuit 120 may set the guard interval of each device (that is, the electronic devices 101-104) in the first group of devices and the second group of devices to the longer second predetermined time to reduce ISI. In other words, after obtaining the above grouping information, the controller circuit 120 may generate the trigger frame TF based on the above grouping information and the corresponding guard interval such that at least one group of devices in the first group of devices or the second group of devices responds to the trigger frame TF and uses the corresponding guard interval to upload data to the communication device 100 (that is, operation S250).

In some related approaches when there is a need for devices to upload data simultaneously, a communication device will set guard intervals of all electronic devices to a maximum predetermined time through a trigger frame, in order to avoid ISI. However, this arrangement causes guard intervals of the packets to become longer and lengthens the data length of a long training field in the packet, resulting in a reduction in the proportion of payload data and a decrease in channel usage. Compared with the related approaches, in some embodiments of the present disclosure, the controller circuit 120 may set a corresponding guard interval according to the power delay profile of the electronic devices 101-104 and group the electronic devices 101-104 according to the power delay profile to perform grouped data transmission. Thus, ISI may be avoided, and channel usage may be improved simultaneously. In scenarios where all the electronic devices 101-104 upload data simultaneously, the controller circuit 120 may set guard intervals of all the electronic devices 101-104 to the longer second predetermined time to reduce ISI.

As described above, the communication devices and network control methods provided by some embodiments of the present disclosure may set guard intervals of electronic devices and group the electronic devices by analyzing power delay profile to reduce ISI between the electronic devices and ISI caused by multiple paths of a single electronic device, thereby improving system receiving performance and channel usage rate.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. A communication device, comprising:
a transceiver circuit configured to receive a plurality of packets from a plurality of electronic devices; and
a controller circuit configured to:
parse the plurality of packets to obtain a power delay profile of each of the plurality of electronic devices;
set a guard interval of each of the plurality of electronic devices according to the power delay profile;
divide the plurality of electronic devices into a first group of devices and a second group of devices according to the guard interval; and
send, through the transceiver circuit, a trigger frame to at least one group of devices in the first group of devices or the second group of devices, so that the at least one group of devices uploads data to the transceiver circuit.

2. The communication device of claim 1, wherein the power delay profile is configured to indicate a relationship between a plurality of signal strength of a first device in the plurality of electronic devices received by the transceiver circuit through multiple paths and a plurality of delay times, and if the controller circuit determines that a sum of the plurality of signal strength in a first predetermined time exceeds a threshold value, the controller circuit sets the guard interval of the first device to the first predetermined time.

3. The communication device of claim 2, wherein if the controller circuit determines that the sum of the plurality of signal strength in the first predetermined time does not exceed the threshold value, the controller circuit sets the guard interval of the first device to a second predetermined time that is longer than the first predetermined time.

4. The communication device of claim 2, wherein the controller circuit is further configured to set the threshold value according to a sum of the plurality of signal strength.

5. The communication device of claim 4, wherein the threshold value is 60% of the sum of the signal strength.

6. The communication device of claim 1, wherein the controller circuit is configured to divide devices in the plurality of electronic devices having the guard interval equal to a first predetermined time into the first group of devices and divide devices in the plurality of electronic devices having the guard interval equal to a second predetermined time into the second group of devices, and the second predetermined time is longer than the first predetermined time.

7. The communication device of claim 1, wherein a guard interval of each device in the first group of devices is a first predetermined time, a guard interval of each device in the second group of devices is a second predetermined time that is longer than the first predetermined time, and if the at least one group of devices comprises the first group of devices and the second group of devices, the controller circuit, through the trigger frame, sets the guard interval of each device in the first group of devices and the second group of devices to the second predetermined time.

8. A network control method, performed by a communication device, the network control method comprising:
receiving a plurality of packets from a plurality of electronic devices;
parsing the plurality of packets to obtain a power delay profile of each of the plurality of electronic devices;
setting a guard interval of each of the plurality of electronic devices according to the power delay profile;
dividing the plurality of electronic devices into a first group of devices and a second group of devices according to the guard interval; and
sending a trigger frame to at least one group of devices in the first group of devices or the second group of devices, so that the at least one group of devices uploads data to the communication device.

9. The network control method of claim 8, wherein the power delay profile is configured to indicate a relationship between a plurality of signal strength of a first device in the plurality of electronic devices received by the communication device through multiple paths and a plurality of delay times, and wherein setting the guard interval of each of the plurality of electronic devices according to the power delay profile comprises:
if a sum of the plurality of signal strength in a first predetermined time exceeds a threshold value, setting the guard interval of the first device to the first predetermined time; and
if the sum of the plurality of signal strength in the first predetermined time does not exceed the threshold value, setting the guard interval of the first device to a second predetermined time that is longer than the first predetermined time.

10. The network control method of claim 9, further comprising:
setting the threshold value according to a sum of the plurality of signal strength.

11. The network control method of claim 10, wherein the threshold value is 60% of the sum of the plurality of signal strength.

12. The network control method of claim 8, wherein dividing the plurality of electronic devices into the first group of devices and the second group of devices according to the guard interval comprises:
dividing devices in the plurality of electronic devices having the guard interval equal to a first predetermined time into the first group of devices; and
dividing devices in the plurality of electronic devices having the guard interval equal to a second predetermined time into the second group of devices, wherein the second predetermined time is longer than the first predetermined time.

13. The network control method of claim 8, wherein a guard interval of each device in the first group of devices is a first predetermined time, a guard interval of each device devices in the second group of devices is a second predetermined time that is longer than the first predetermined time, and sending the trigger frame to the at least one group of devices in the first group of devices or the second group of devices, so that the at least one group of devices uploads data to the communication device comprises:
if the at least one group of devices comprises the first group of devices and the second group of devices, sending the trigger frame to set the guard interval of each device in the first group of devices and the second group of devices to the second predetermined time.
